(19) United States
(12) Patent Application Publication
(10) Pub. No.: US 2012/0158850 A1
(43) Pub. Date: Jun. 21, 2012

(54) METHOD AND APPARATUS FOR AUTOMATICALLY CREATING AN EXPERIENTIAL NARRATIVE

(76) Inventors: Edward R. Harrison, Beaverton, OR (US); David A. Sandage, Forest Grove, OR (US)

(21) Appl. No.: 12/975,133

(22) Filed: Dec. 21, 2010

(51) Int. Cl. G06F 15/16

(52) U.S. Cl. 709/205

(57) ABSTRACT

Embodiments of a method and apparatus for automatically generating an experiential narrative are described. A method may comprise, for example, receiving media information, receiving context information based on one or more identifiers associated with the media information, correlating the media information and the context information, and automatically generating a narrative summary using the correlated media information and context information. Other embodiments are described and claimed.

### BACKGROUND

The performance of modern computing systems has increased rapidly in recent years. One particular area in which performance has evolved is system functionality. Many modern computing systems include a plurality of devices for performing a variety of functions, including devices for capturing media and determining locations. Additionally, a growing number of users are relying on social and web based media to share stories, experiences and other media information. As the functionality of mobile computing systems continues to increase and the use of social and web based media continues to expand, managing the transfer of content to social and web based media becomes an important consideration. As a result, it is desirable to simplify the process of sharing media information. Consequently, there exists a substantial need for techniques to automatically create an experiential narrative.

### BRIEF DESCRIPTION OF THE DRAWINGS

FIG. 1 illustrates one embodiment of a first system.

FIG. 2A illustrates one embodiment of an apparatus.

FIG. 2B illustrates one embodiment of a first logic diagram.

FIG. 3 illustrates one embodiment of a second logic diagram.

FIG. 4 illustrates one embodiment of a second system.

### DETAILED DESCRIPTION

Embodiments are generally directed to techniques designed to automatically create an experiential narrative. Various embodiments provide techniques that include receiving media information, receiving context information, correlating the media information and the context information and automatically generating a narrative summary using the correlated media information and context information. Other embodiments are described and claimed.

With the progression over time toward the combined use of advanced mobile computing devices and social media, the sharing of stories, experiences and other media information on the web has steadily risen. For example, digital cameras that record geographic coordinates into the EXIF header of photos are becoming readily available. Additionally, supplemental global positioning system (GPS) hardware is available that allows user to manually “geotag” their photos. In various embodiments, geotagged photos are being used on the web to create a variety of new rich experiences.

In addition to high-end cameras and supplemental GPS hardware, more and more mobile computing devices such as phones, smartphones, PDA's, tablets and mobile internet devices contain context sensors such as GPS, radio frequency identification (RFID) readers, electronic compasses and other sensors that are capable of recording a great deal of context data about a user's location and activities. More and more people are using the Internet to share their stories and experiences ranging from normal day-to-day life activities to trips and vacations. Stories are being created in the form of Web logs (blogs), photo albums, videos and multimedia presentations. Improvement of the tools available to document and share these experiences is an important consideration.

Many modern systems require a lot of time and effort on the part of the user to generate all of the content that they wish to share. Currently available tools used to generate blogs or stories often require that the user assemble all the media and create a time line and narrative manually. The user must remember where they went and what they did in order to construct a narrative of an event or experience. The user must also manually insert pictures and videos in the correct sequence within the narrative. This drudgework is time consuming and may be beyond the computing abilities of some users. As a result, it may be advantageous to automatically combine user-created media with automatically created context data to automatically create the framework of a rich blog entry or multimedia presentation that can then be edited by the user to fill in details, commentary, and other information. The basic narrative of where a user went, what they did, what they saw, who they were with, etc. may be automatically generated from the context data and combined with the media information to create the framework of a blog. In some embodiments, the context information alone may be sufficient to track a users activities and media information may not be necessary for the automatic generation. Other embodiments are described and claimed.

Embodiments may include one or more elements. An element may comprise any structure arranged to perform certain operations. Each element may be implemented as hardware, software, or any combination thereof, as desired for a given set of design parameters or performance constraints. Although embodiments may be described with particular elements in certain arrangements by way of example, embodiments may include other combinations of elements in alternate arrangements.

It is worthy to note that any reference to “one embodiment” or “an embodiment” means that a particular feature, structure, or characteristic described in connection with the embodiment is included in at least one embodiment. The appearances of the phrases “in one embodiment” and “in an embodiment” in various places in the specification are not necessarily all referring to the same embodiment.

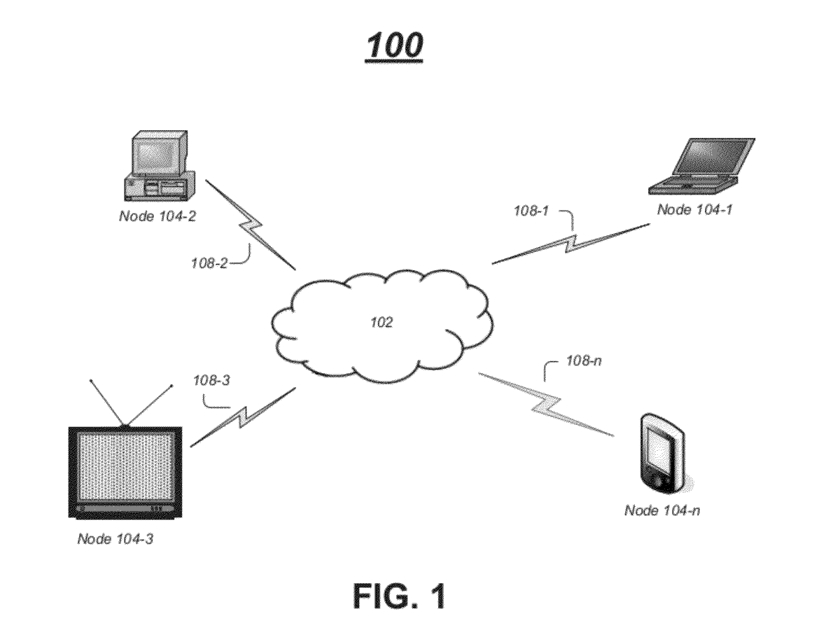

FIG. 1 illustrates a block diagram of one embodiment of a communications system 100. In various embodiments, the communications system 100 may comprise multiple nodes. A node generally may comprise any physical or logical entity for communicating information in the communications system 100 and may be implemented as hardware, software, or any combination thereof, as desired for a given set of design parameters or performance constraints. Although FIG. 1 may show a limited number of nodes by way of example, it can be appreciated that more or less nodes may be employed for a given implementation.

In various embodiments, the communications system 100 may comprise, or form part of a wired communications system, a wireless communications system, or a combination of both. For example, the communications system 100 may include one or more nodes arranged to communicate information over one or more types of wired communication links. Examples of a wired communication link, may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The communications system 100 also may include one or more nodes arranged to communicate information over one or more types of wireless communication links. Examples of a wireless communication link may include, without limitation, a radio channel, infrared channel, radio-frequency (RF) channel, Wireless Fidelity (WiFi) channel, a portion of the RF spectrum, and/or one or more licensed or license-free frequency bands.

The communications system 100 may communicate information in accordance with one or more standards as promulgated by a standards organization. In one embodiment, for example, various devices comprising part of the communications system 100 may be arranged to operate in accordance with one or more of the IEEE 802.11 standard, the WiGig Alliance™ specifications, WirelessHD™ specifications, standards or variants, such as the WirelessHD Specification, Revision 1.0d7, Dec. 1, 2007, and its progeny as promulgated by WirelessHD, LLC (collectively referred to as the “WirelessHD Specification”), or with any other wireless standards as promulgated by other standards organizations such as the International Telecommunications Union (ITU), the International Organization for Standardization (ISO), the International Electrotechnical Commission (IEC), the Institute of Electrical and Electronics Engineers (information IEEE), the Internet Engineering Task Force (IETF), and so forth. In various embodiments, for example, the communications system 100 may communicate information according to one or more IEEE 802.11 standards for wireless local area networks (WLANs) such as the information IEEE 802.11 standard (1999 Edition, Information Technology Telecommunications and Information Exchange Between Systems—Local and Metropolitan Area Networks—Specific Requirements, Part 11: WLAN Medium Access Control (MAC) and Physical (PHY) Layer Specifications), its progeny and supplements thereto (e.g., 802.11a, b, g/h, j, n, VHT SG, and variants); IEEE 802.15.3 and variants; IEEE 802.16 standards for WMAN including the IEEE 802.16 standard such as 802.16-2004, 802.16.2-2004, 802.16e-2005, 802.16f, and variants; WGA (WiGig) progeny and variants; European Computer Manufacturers Association (ECMA) TG20 progeny and variants; and other wireless networking standards. The embodiments are not limited in this context.

The communications system 100 may communicate, manage, or process information in accordance with one or more protocols. A protocol may comprise a set of predefined rules or instructions for managing communication among nodes. In various embodiments, for example, the communications system 100 may employ one or more protocols such as a beam forming protocol, medium access control (MAC) protocol, Physical Layer Convergence Protocol (PLCP), Simple Network Management Protocol (SNMP), Asynchronous Transfer Mode (ATM) protocol, Frame Relay protocol, Systems Network Architecture (SNA) protocol, Transport Control Protocol (TCP), Internet Protocol (IP), TCP/IP, X.25, Hypertext Transfer Protocol (HTTP), User Datagram Protocol (UDP), a contention-based period (CBP) protocol, a distributed contention-based period (CBP) protocol and so forth. In various embodiments, the communications system 100 also may be arranged to operate in accordance with standards and/or protocols for media processing. The embodiments are not limited in this context.

As shown in FIG. 1, the communications system 100 may comprise a network 102 and a plurality of nodes 104-1-n, where n may represent any positive integer value. In various embodiments, the nodes 104-1-n may be implemented as various types of wireless devices. Examples of wireless devices may include, without limitation, a laptop computer, ultra-laptop computer, portable computer, personal computer (PC), notebook PC, handheld computer, personal digital assistant (PDA), cellular telephone, combination cellular telephone/PDA, smartphone, pager, messaging device, media player, digital music player, set-top box (STB), appliance, workstation, user terminal, mobile unit, consumer electronics, television, digital television, high-definition television, television receiver, high-definition television receiver, table computer, an IEEE 802.15.3 piconet controller (PNC), a controller, an IEEE 802.11 PCP, a coordinator, a station, a subscriber station, a base station, a wireless access point (AP), a wireless client device, a wireless station (STA), and so forth.

In some embodiments, the nodes 104-1-n may comprise one more wireless interfaces and/or components for wireless communication such as one or more transmitters, receivers, transceivers, chipsets, amplifiers, filters, control logic, network interface cards (NICs), antennas, antenna arrays, modules and so forth. Examples of an antenna may include, without limitation, an internal antenna, an omni-directional antenna, a monopole antenna, a dipole antenna, an end fed antenna, a circularly polarized antenna, a micro-strip antenna, a diversity antenna, a dual antenna, an antenna array, and so forth.

In various embodiments, the nodes 104-1-n may comprise or form part of a wireless network 102. In one embodiment, for example, the wireless network 102 may comprise a Millimeter-Wave (mmWave) wireless network operating at the 60 Gigahertz (GHz) frequency band, a WPAN, a Wireless Local Area Network (WLAN), a Wireless Metropolitan Area Network, a Wireless Wide Area Network (WWAN), a Broadband Wireless Access (BWA) network, a radio network, a television network, a satellite network such as a direct broadcast satellite (DBS) network, and/or any other wireless communications network configured to operate in accordance with the described embodiments. In some embodiments, the network 102 may comprise or represent the Internet or any other system of interconnected computing devices. The embodiments are not limited in this context.

In some embodiments, one or more of the nodes 104-1-n may comprise a mobile computing device capable of capturing media information and sharing the media information with another mobile computing device 104-1-n. For example, node 104-n may comprise a smartphone including a camera and GPS module. In various embodiments, the smartphone 104-n may be operative to capture media information such as photos or videos using the camera, tag the media information with location information from the GPS module and automatically share the media information with node 104-1 which may comprise, in some embodiments, a web server or social media server. The embodiments are not limited in this context.

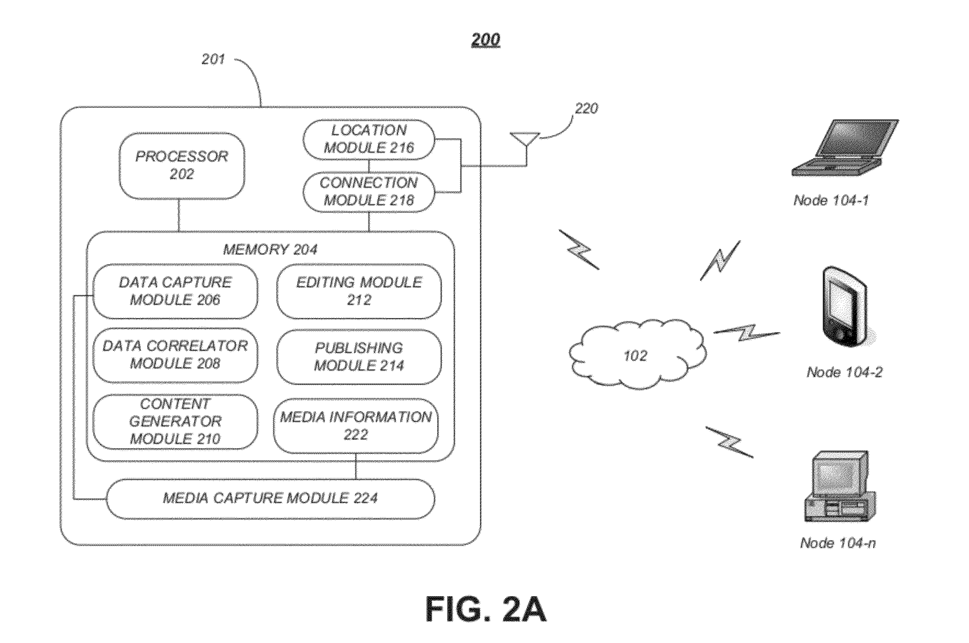

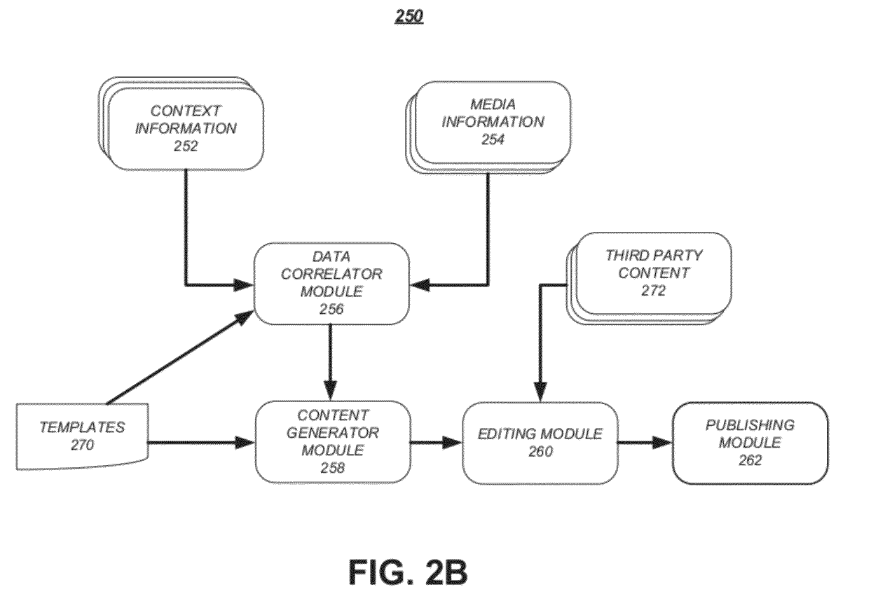

FIG. 2A illustrates a block diagram of one embodiment of a communications system 200. In various embodiments, the communications system 200 may be the same or similar to communications system 100 of FIG. 1. As shown in FIG. 2A, communications system 200 includes, but is not limited to, nodes 104-1-n and a mobile computing device 201. It should be understood that mobile computing device 201 of FIG. 2A may comprise a more detailed view of any of nodes 104-1-n. Although FIG. 2A may show a limited number of nodes and components by way of example, it can be appreciated that more or less nodes, components or elements may be employed for a given implementation.

Mobile computing device 201 may comprise a computing system or device in some embodiments. As shown in FIG. 2A, mobile computing device 201 comprises multiple elements, such as processor 202, memory 204, data capture module 206, data correlator module 208, content generator module 210, editing module 212, publishing module 214, location module 216, connection modules 218, transceiver system 220, media information 222 and media capture module 224. The embodiments, however, are not limited to the elements or the configuration shown in this figure. For example, while certain elements and modules are shown as being separate in FIG. 2A, it should be understood that these elements and modules could be combined and still fall within the described embodiments. Furthermore, while multiple modules are illustrated in FIG. 2A as being included in memory 204, it should be understood that other arrangements of the modules are possible and the embodiments are not limited in this context.

In various embodiments, processor 202 may comprise a central processing unit comprising one or more processor cores. The processor 202 may include any type of processing unit, such as, for example, CPU, multi-processing unit, a reduced instruction set computer (RISC), a processor that have a pipeline, a complex instruction set computer (CISC), digital signal processor (DSP), and so forth. In some embodiments, processor 202 may comprise or include logical and/or virtual processor cores. Each logical processor core may include one or more virtual processor cores in some embodiments.

In various embodiments, memory 204 may comprise any suitable type of memory unit, memory device, memory article, memory medium, storage device, storage article, storage medium and/or storage unit, for example, memory, removable or non-removable media, volatile or non-volatile memory or media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like.

In some embodiments, modules 206, 208, 210, 212, 214, 216, 218 and 224 may comprise software drivers or applications to manage various aspects of mobile computing device 201. In various embodiments, the modules 206, 208, 210, 212, 214, 216, 218 and 224 may comprise software drivers or applications running under an operating system (OS) for mobile computing device 201. It should be understood that while one arrangement, type and number of modules is shown in computing system 200 for purposes of illustration, other arrangements, types and numbers of modules are possible. For example, in some embodiments some or all of modules 206, 208, 210, 212, 214, 216, 218 and 224 may be located in devices other than mobile computing device 201. Other embodiments are described and claimed.

In various embodiments, communications system 200 may be operative to automatically generate an experiential narrative. For example, mobile computing device 201 may include a data capture module 206 operative to gather context data and/or media from one or more sources, a data correlator module 208 operative to summarize and correlate the context data and/or media, and a content generator module 210 operative to transform the correlated data into human readable content that can then optionally be edited by a user. In some embodiments, the modules may reside in any of several platforms including one or more mobile client devices, a user's home PC, or an Internet service or web server.

In one embodiment, for example, the automatic generation may be implemented as a web service. When a user wants to create an automatic blog, he may use either a mobile device or a home PC to make a request to an autoblog web service. In various embodiments, the request may include a template specifying the time frame and location of the various pieces of context data and media. The service may be operative to gather the context data and media, correlate it, and generate a summarization in the form of an HTML blog entry. The blog entry may then be viewed and edited by the user in a web-based editing tool. In some embodiments, the editing tool may suggest third party mashups to enrich the final creation. In a final step, the blog may be shared with friends and family. The embodiments are not limited in this context.

As shown in FIG. 2A, mobile computing device 201 may include a data capture module 206 in some embodiments. Data capture module 206 may be operative to receive media information and to automatically retrieve context information associated with the media information in various embodiments. For example, data capture module 206 may be operative to receive media information from media capture module 224 in some embodiments. In various embodiments, the media capture module 224 may comprise one or more of a still camera, video camera, scanner, recorder or other suitable media capture device and the media information may comprise one or more of picture data, video data, voice data or intelligent sign data captured by media capture module 224.

Data capture module 206 may also be operative to automatically retrieve context information associated with the media information 222 in some embodiments. For example, after receiving media information 222, data capture module 206 may be operative to retrieve one or more of location information or event information associated with the media information. The location information or event information may be retrieved based on one or more identifiers associated with the media information 222. In some embodiments, the one or more identifiers may comprise tags or other identifiers associated with the media information when the media information is captured by media capture module 224.

In various embodiments, data capture module 206 may be operative to retrieve or capture context information independent of media information. For example, context information need not be associated with media information to be relevant. In some embodiments, the context information may include information about where a user went, what a user did, who a user was with, etc. This information may, by itself, be useful in automatically creating an experiential narrative.

Mobile computing device 201 may include a location module 212 in some embodiments. In various embodiments, the location module 216 may be operative to determine a location of the apparatus or mobile computing device 201 at least when the mobile computing device 201 captures media information and data capture module 206 may be operative to associate the determined location with the media information 222. For example, the location module 216 may comprise a global positioning system (GPS) in some embodiments. In various embodiments, location module 212 may additionally be operative to capture location information at other times, including periodically recording location information even when media information is not being captured.

In some embodiments, location module 216 may be arranged to retrieve, generate or provide fixed device position information for the device 201. For example, during installation location module 216 may be provisioned or programmed with position information for the device 201 sufficient to locate a physical or geographic position for the device 201. The device position information may comprise information from a geographic coordinate system that enables every location on the earth to be specified by the three coordinates of a spherical coordinate system aligned with the spin axis of the Earth. For example, the device position information may comprise longitude information, latitude information, and/or elevation information. In some cases, location module 216 may implement a location determining technique or system for identifying a current location or position for the device 201. In such cases, location module 216 may comprise, for example, a Global Positioning System (GPS), a cellular triangulation system, and other satellite based navigation systems or terrestrial based location determining systems. This may be useful, for example, for automatically associating location information with media information. The embodiments are not limited in this context.

Data capture module 206 may also be operative to automatically associate a time, event, elevation or any other relevant identifiers with the media information 222 at the time of capture. In some embodiments, the one or more identifiers associated with the media information 222 may be used by data capture module 206 to retrieve context information for the media information 222. The context information may comprise, in some embodiments, information about the location, time or an event where the media information 222 was captured. For example, data capture module 206 may receive latitude and longitude coordinates associated with a location for a photograph captured by a camera of the mobile computing device 201. The data capture module 206 may be operative to obtain context information based on the latitude and longitude information in some embodiments. For example, mobile computing device 201 may contain a database of information regarding a plurality of locations and events in some embodiments. In various embodiments, data capture module 206 may be operative to obtain the context information from one or more third party sources, such as a web database. For example, data capture module 206 may be operative to retrieve the context information from one or more web based travel guides from Fodor's or any other relevant source. The embodiments are not limited in this context.

In some embodiments, data capture module 206 may also be operative to automatically capture or retrieve context information that is not associated with media information. For example, data capture module 206 may be operative to automatically and/or periodically track the location of a device, the speed at which a device is moving, what devices are nearby, etc. This additional information may be useful in creating an experiential narrative. In various embodiments, for example, an experiential narrative could be created with limited or no media information. In this example, the context information could be used to create the experiential narrative.

In various embodiments, data correlator module 208 may be operative to correlate the media information and the context information. Correlating the media information and context information may comprise combining or otherwise associating media information with context information that is related to the media information. By correlating the media information and context information, a content generator module 210 may be operative to generate a human readable summary of the correlated media information and context information in some embodiments. For example, a narrative summary of one or more events associated with media information may be presented in the form of an HTML blog entry. One example of correlating the media information and context information may comprise reverse geocoding wherein a point location (e.g. latitude, longitude) is reverse coded to a readable address, place name or other meaningful place name which may permit the identification of nearby street addresses, places, and/or areal subdivision such as a neighborhood, county, state, or country. Other embodiments are described and claimed.

In various embodiments, correlator module 208 may be operative to correlate multiple streams of context information. For example, context information relating to nearby devices, time, location and other parameters may be simultaneously received. In this example, correlator module 208 may be operative to correlate these multiple streams of context information to create a more robust account of a user's activities.

An editing module 212 may be operative to receive detail information for the correlated media information and/or context information and to combine the detail information and the correlated media information and/or context information in some embodiments. For example, the detail information may be received from a user in some embodiments to supplement the automatically generating narrative summary. The detail information may comprise additional details about the media information or may include information to supplement the automatically retrieved context information in some embodiments. In various embodiments, the editing module 212 may comprise an HTML editing tool operative to allow a user to make changes to and otherwise manipulate the automatically generated narrative summary to prepare the information for publication.

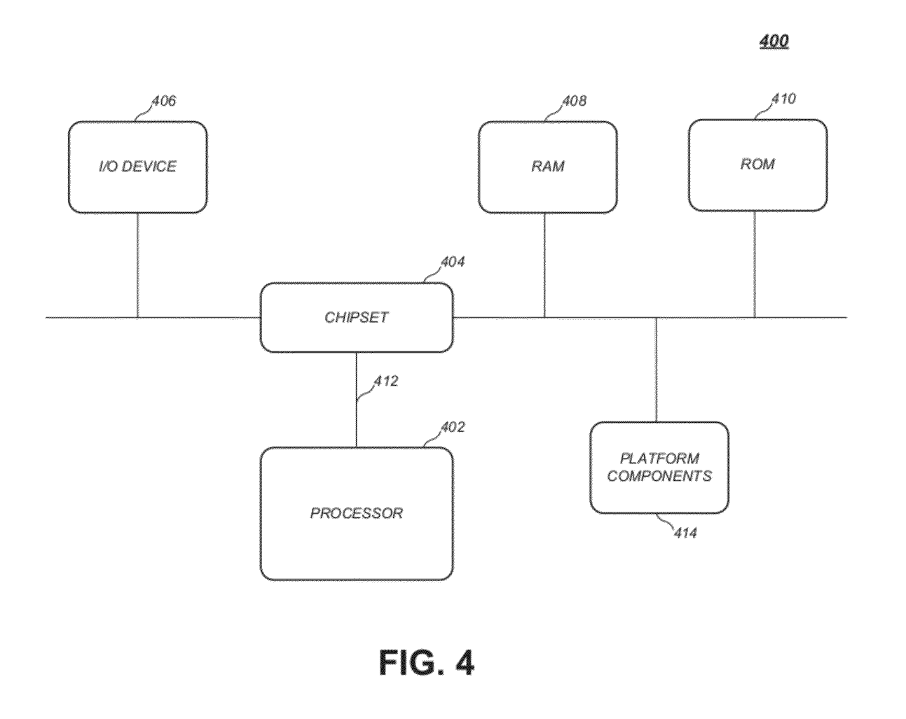

In various embodiments, a publishing module operative to send the combined detail information, media information and context information to one or more web servers for publication. For example, the publishing module 214 may be operative to generate one or more of a web log, blog, photo album, video, multimedia presentation, slide show, photo book, published work, Facebook page or entry, Twitter entry, YouTube Video, etc. and transmit the finished product to one or more web servers such as a social media service, blog hosting website, another computing device or any other suitable destination such as one or more publishing devices. In some embodiments, the finished product is transmitted using a connection module 218 and antenna 220 that may be the same or similar to the transceiver and antenna described above. Other embodiments are described and claimed. Additional details regarding mobile computing device 201 or any of nodes 104-1-n are described below with reference to FIG. 4.

While various embodiments described herein include the gathering, correlation, summarization and publishing being performed by mobile computing device 201, it should be understood that the embodiments are not limited in this context. For example, any or all of the modules described above with reference to FIG. 2A may be implemented in any number of devices. In various embodiments, media information may be captured or recorded by the same device that performs correlating, summarizing and uploading of the data. In other embodiments, media information may be periodically uploaded to one or more web servers or other computing devices that are operative to perform the above-described functions. For example, a mobile computing device may be used to capture media information and the media information may be automatically or periodically uploaded to a web server for later viewing, editing and finalizing. In various embodiments, the web service may be operative to be executed by the mobile computing device. These and other embodiments fall within the described embodiments.

FIG. 2B illustrates one embodiment of a logic flow 250. The logic flow 250 may be performed by various systems and/or devices and may be implemented as hardware, software, firmware, and/or any combination thereof, as desired for a given set of design parameters or performance constraints. For example, one or more operations of the logic flow 250 may be implemented by executable programming or computer-readable instructions to be executed by a logic device (e.g., computer, processor). Logic flow 250 may describe the automatic generation of an experiential narrative as described above with reference to FIGS. 1 and 2A. It should be understood that the logic flow 250 may be implemented by one or more devices.

As shown in FIG. 2B, media information 254 and context information 252 may be gathered by data correlator module 256 in some embodiments. For example, data correlator module 256 may be operative to gather, receive or retrieve media information 254 comprising photos, videos or other information and context information 252 comprising information or details about the media information. In some embodiments, the media information 254 is received from a mobile computing device used to capture the media information and the context information 252 is retrieved from one or more third party sources such as a web based database or travel guide.

In various embodiments, the context information may include, but is not limited to, one or more of picture data, video data, voice data, intelligent sign data, location information, electronic compass information, RFID information, proximity sensor information, data from one or more web services, weather information, traffic information or data from one or more applications such as appointment information from a calendar application. In some embodiments, the context information may include or comprise derived context data. For example, derived context data may comprise a combination and/or analysis of one or more streams or pieces of context data to produce one or more streams or pieces of additional context data. A limited number and type of context information is described for purposes of illustration and not limitation.

In various embodiments, data correlator module 256 may also be operative to receive one or more templates 270. The templates 270 may comprise one or more pre-developed page layouts used to make new pages with a similar design, pattern, or style. For example, the templates 270 may be available to a user and the user may select a template 270 when creating a experiential narrative, wherein the templates provide the style, layout or skeleton of the narrative. Other embodiments are described and claimed.

The combined media information 254, context information 252 and selected template 270 may be received by the content generator module 258 in some embodiments. For example, the data correlator module 256 may combine the context information 252 and media information 254 and provide the combination or the context information 252 or media information 254 independently to the content generator module 258 that may be operative to arrange the information in a pre-defined formal according to the selected and received template 270. The content generator module 258 may be operative to create a narrative summary of the events represented by the media information.

An editing module 260 may be operative to receive the narrative summary and third party content 272 in some embodiments. The editing module may comprise an HTML editing tool, application or other type of interactive editor operative to allow a user to interact with and make changes to the narrative summary generated by the content generator module 258. In various embodiments, the third party content 272 may comprise weblinks, hyperlinks, maps or other detail information that is selected by the user or automatically selected by the content editor for inclusion with the combined media information 254 and context information 252. The editing module 260 may also be operative to allow a user to add captions, descriptions, comments or other detail information that may further enhance the narrative summary.

In some embodiments, the combined narrative summary, third party content 272 and other detail information may be finalized and provided to a publishing module 262 that may be operative to publish the final product to one or more web servers or otherwise make the final product available to one or more users. For example, the publishing module 262 may submit the combined information in the form of a blog to a one or more weblog websites. In other embodiments, the publishing module 262 may provide the final product to other computing devices or users, or may print the final product in one or more human readable formats such as a book, photo album or other suitable format. The embodiments are not limited in this context.

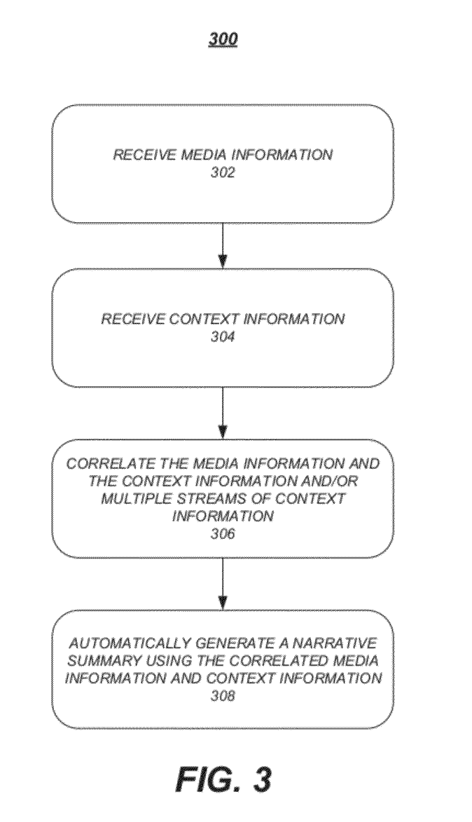

FIG. 3 illustrates one embodiment of a logic flow 300. The logic flow 300 may be performed by various systems and/or devices and may be implemented as hardware, software, firmware, and/or any combination thereof, as desired for a given set of design parameters or performance constraints. For example, one or more operations of the logic flow 300 may be implemented by executable programming or computer-readable instructions to be executed by a logic device (e.g., computer, processor). Logic flow 300 may describe the automatic generation of an experiential narrative as described above with reference to FIGS. 1, 2A and 2B.

In various embodiments, media information may be received at 302. For example, media information comprising one or more of picture data, video data, voice data, intelligent sign data, electronic compass data, RFID data, proximity sensor data, web service data, weather data, traffic data or application data may be captured by a camera or other media capture device of a mobile computing device and this media information may be used by the mobile computing device or may be provided to another device or web server for use in automatically generating an experiential narrative. In some embodiments, context information based on one or more identifiers associated with the media information may be received at 304. In various embodiments, the context information need not be associated with media information and may still be received at 304. For example, the media information may be tagged with time, location or other relevant identifiers and these identifiers may be used to gather information about the place, time or event associated with the media information. In other embodiments, the context information may be received independent of media information and may be used in whole or in part to create the experiential narrative. The context information may comprise one or more of location detail information, event detail information, intelligent sign data, electronic compass data, RFID data, proximity sensor data, web service data, weather data, traffic data or application data in some embodiments. The embodiments are not limited in this context.

The media information and the context information may be correlated at 306 in some embodiments. In some embodiments, multiple streams of context information may also be correlated at 306. For example, a mobile computing device or web service may be operative to combine the relevant media information and context information. In other embodiments, a mobile computing device or web service may be operative to combine multiple streams of context information to generate a detailed account of the movement, speed, location, nearby devices or other relevant information that may be useful to include in the experiential narrative.

In various embodiments, a narrative summary may be automatically generated using the correlated media information and context information at 308. For example, by automatically generating the narrative summary, the traditionally labor intensive task of sorting through media information and combing that information with relevant location, time and event details can be automatically completed by a computing device rather than by a user.

In various embodiments, the narrative summary may be presented in a viewable or audible format. For example, the combined media information and context information may be presented in a human readable form so a user can view the combined information. This combined information may be presented, for example, on a digital display of a computing device or it may be printed on hard copy. The narrative summary may comprise an ordered collection of correlated media information and context information in some embodiments. The ordered summary may comprise one or more of a timeline representing a series of events associated with the media information or a geographic representation of events associated with the media information. Other embodiments are described and claimed.

Detail information to supplement the narrative summary may be received in some embodiments. The detail information may comprise third party content retrieved from one or more databases, or may comprise details that are provided by a user to supplement the automatically retrieved context information. The detail information may help to develop or provide a more informative and enjoyable final product.

Narrative content may be generated using the narrative summary and detail information in some embodiments. For example, the narrative content may comprise a completed blog, multimedia presentation, slideshow, book, photo book, Facebook page or entry, Twitter entry or Tweet or other completed content or final product to be viewed by one or more users. In some embodiments, the narrative content may comprise one or more of a web log, blog, photo album, video, multimedia presentation, slideshow, book, photo book, Facebook page or entry or Twitter entry. The embodiments are not limited in this context. In various embodiments, the narrative content may be published to one or more web servers or other computing devices. For example, the completed web blog may be posted to one or more websites in some embodiments.

In some embodiments, to receive the context information, a connection may be established with one or more context information providers, the identifiers associated with the media information may be sent to the one or more context information providers, and the context information may be received from the one or more context information providers. For example, the context information providers may comprise one or more of a local database, remote database or other source, such as a travel website. In various embodiments, the connection may comprise a connection established using a wireless network and the identifiers may be provided to the providers using the wireless network. The embodiments are not limited in this context.

Context information may also include or be received from sensors on the device like still camera, video camera, a GPS, compass, RFID reader, application data such as appointment calendar, and computed context data such who a user is with which may be computed from your location plus another user's location and/or based on proximity sensor or other close range communication protocol or technology. In various embodiments, the context information may be used to perform higher-level analysis to further enhance the automatically created experiential narrative. For example, in one embodiment, accelerometer data and the speed or velocity of a device may comprise context information that is captured by a device. This information may be combined, for example, to determine if a user is walking, running, riding in a vehicle, etc. and this additional context information may enhance the final experiential narrative product.

While various embodiments are described with reference to particular devices, media information, context information and experiential narrative summary types, it should be understood that the embodiments are not limited in this context. For example, various embodiments refer to the automatic creation of a blog or web log. One skilled in the art will appreciate that any suitable type or format of experiential narrative could be used and still fall within the described embodiments. Similarly, a limited number and type of media information and context information are described throughout. The embodiments are not limited to the number, type or arrangement of information set forth herein as one skilled in the art will appreciate.

FIG. 4 is a diagram of an exemplary system embodiment. In particular, FIG. 4 is a diagram showing a system 400, which may include various elements. For instance, FIG. 4 shows that system 400 may include a processor 402, a chipset 404, an input/output (I/O) device 406, a random access memory (RAM) (such as dynamic RAM (DRAM)) 408, and a read only memory (ROM) 410, and various platform components 414 (e.g., a fan, a crossflow blower, a heat sink, DTM system, cooling system, housing, vents, and so forth). These elements may be implemented in hardware, software, firmware, or any combination thereof. The embodiments, however, are not limited to these elements.

As shown in FIG. 4, I/O device 406, RAM 408, and ROM 410 are coupled to processor 402 by way of chipset 404. Chipset 404 may be coupled to processor 402 by a bus 412. Accordingly, bus 412 may include multiple lines. In various embodiments, chipset 404 may be interested or packaged with processor 402. Other embodiments are described and claimed.

Processor 402 may be a central processing unit comprising one or more processor cores and may include any number of processors having any number of processor cores. The processor 402 may include any type of processing unit, such as, for example, CPU, multi-processing unit, a reduced instruction set computer (RISC), a processor that have a pipeline, a complex instruction set computer (CISC), digital signal processor (DSP), and so forth.

Although not shown, the system 400 may include various interface circuits, such as an Ethernet interface and/or a Universal Serial Bus (USB) interface, and/or the like. In some exemplary embodiments, the I/O device 406 may comprise one or more input devices connected to interface circuits for entering data and commands into the system 400. For example, the input devices may include a keyboard, mouse, touch screen, track pad, track ball, isopoint, a voice recognition system, and/or the like. Similarly, the I/O device 406 may comprise one or more output devices connected to the interface circuits for outputting information to an operator. For example, the output devices may include one or more displays, printers, speakers, and/or other output devices, if desired. For example, one of the output devices may be a display. The display may be a cathode ray tube (CRTs), liquid crystal displays (LCDs), or any other type of display.

The system 400 may also have a wired or wireless network interface to exchange data with other devices via a connection to a network. The network connection may be any type of network connection, such as an Ethernet connection, digital subscriber line (DSL), telephone line, coaxial cable, etc. The network may be any type of network, such as the Internet, a telephone network, a cable network, a wireless network, a packet-switched network, a circuit-switched network, and/or the like.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable or computer-readable medium or article which may store an instruction, a set of instructions or computer executable code that, if executed by a machine or processor, may cause the machine or processor to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, volatile or non-volatile memory or media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter that lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An article comprising a computer-readable storage medium containing instructions that when executed by a processor enable a system to:
receive media information;
receive context information;
correlate the media information and the context information or correlate multiple streams of context information; and
automatically generate a narrative summary using the correlated media information and context information or correlated streams of context information.

2. The article of claim 1, comprising instructions that if executed enable the system to:
present the narrative summary in a viewable format;
receive detail information to supplement the narrative summary;
generate narrative content using the narrative summary and detail information; and
publish the narrative content to one or more web servers.

3. The article of claim 1, wherein the media information comprises one or more of picture data, video data, voice data, web services data, application data, intelligent sign data or derived context data and one or more identifiers associated with the media information comprise one or more of time information, location information, weather information, traffic information or appointment information.

4. The article of claim 1, wherein the context information comprises one or more of location detail information, event detail information, compass information, radio frequency identification (RFID) information, proximity sensor information, web service information or application information.

5. The article of claim 1, comprising instructions that if executed enable the system to:
establish a connection with one or more context information providers;
send one or more identifiers associated with the media information or the context information to the one or more context information providers; and
receive the context information from the one or more context information providers.

6. The article claim 1, wherein the narrative summary comprises an ordered collection of correlated media information and context information.

7. The article of claim 6, wherein the ordered collection comprises one or more of a timeline representing a series of events associated with the media information, a geographic representation of events associated with the media information or a relationship ordering representing identifiable elements or features of the media information or context information.

8. The article of claim 2, wherein the narrative content comprises one or more of a web log, blog, photo album, video, multimedia presentation, slideshow, photo book or social networking post or entry.

9. The article of claim 1, comprising instructions that if executed enable the system to
receive the media information from one or more mobile computing devices having media capture capabilities and location capabilities.

10. An apparatus, comprising:
a data capture module operative to receive media information and context information;
a data correlator module operative to correlate the media information and the context information or multiple streams of context information; and
a content generator module operative to generate a human readable summary of the correlated media information and context information or correlated streams of context information.

11. The apparatus of claim 10, comprising:
a location module operative to determine a location of the apparatus and to associate the determined location with the media information.

12. The apparatus of claim 10, comprising:
an editing module operative to receive detail information for the correlated media information and context information or correlated streams of context information and to combine the detail information and the correlated media information and context information or correlated streams of context information.

13. The apparatus of claim 12, comprising:
a publishing module operative to send the combined detail information, media information and context information to one or more web servers.

14. The apparatus of claim 10, wherein the media information comprises one or more of picture data, video data, voice data, web services data, application data or intelligent sign data captured by one or more of a camera, microphone, scanner or sensor of the apparatus.

15. The apparatus of claim 10, wherein the context information comprises one or more of location information or event information associated with the media information or information associated with the apparatus.

16. The apparatus of claim 11, wherein the location module comprises a global positioning system (GPS).

17. The apparatus of claim 13, wherein the publishing module is operative to generate one or more of a web log, blog, photo album, video, multimedia presentation, slideshow, photo book or social networking post or entry and the data correlator module is operative to automatically retrieve context information associated with the media information or associated with the apparatus.

18. A computer-implemented method, comprising:
receiving media information;
receiving context information;
correlating the media information and the context information or correlating multiple streams of context information; and
automatically generating a narrative summary using the correlated media information and context information or correlated streams of context information.

19. The computer-implemented method of claim 18, comprising:
receiving the media information from one or more mobile computing devices having media capture capabilities and location capabilities;
establishing a connection with one or more context information providers;
sending the identifiers associated with the media information or the context information to the one or more context information providers;
receiving the context information from the one or more context information providers;
presenting the narrative summary in a viewable format;
receiving detail information to supplement the narrative summary;
generating narrative content using the narrative summary and detail information; and
publishing the narrative content to one or more web servers.

20. The computer-implemented method of claim 18, wherein the media information comprises one or more of picture data, video data, voice data or intelligent sign data, the one or more identifiers associated with the media information comprise one or more of time information or location information, and the context information comprises one or more of location detail information or event detail information.
